(19) United States
(12) Patent Application Publication
(10) Pub. No.: US 2012/0189808 A1
(43) Pub. Date: Jul. 26, 2012

(54) Laminate Materials and Dilatant Compounds for Ballistic Shielding

(75) Inventor: Jay Morell Wendell, The Woodlands, TX (US)

(73) Assignee: Trigon Holdings, LC, Magnolia, TX (US)

(21) Appl. No.: 12/686,952

(22) Filed: Jan. 13, 2010

Related U.S. Application Data
(60) Provisional application No. 61/144,360, filed on Jan. 13, 2009.

(51) Int. Cl. B32B 3/24; B32B 9/04; B32B 27/32; C04B 16/00; B32B 18/00; B32B 27/40; B82Y 30/00

(52) U.S. Cl. 428/138; 428/446; 428/704; 106/483; 977/762

(57) ABSTRACT

In various embodiments, laminate materials having a first layer, second layer and third layer are described herein. The first layer includes a dilatant compound. The second layer is a ceramic material. The third layer includes a strike face material. The second layer is interposed between the first layer and the third layer. In some embodiments, nanomaterials such as HALLOYSITE nanotubes are mixed in the dilatant compound and are cross-linked thereto. Laminate materials of the present disclosure have beneficial properties for ballistic shielding for both persons and equipment. Dilatant compounds formed from a silicone fluid and a nanomaterial functionalized with at least one silane coupling agent are also described herein.

### CROSS-REFERENCE TO RELATED APPLICATIONS

This application claims priority to U.S. provisional patent application 61/144,360, filed Jan. 13, 2009, which is incorporated by reference herein in its entirety.

### STATEMENT REGARDING FEDERALLY SPONSORED RESEARCH

Not applicable.

### BACKGROUND

Enhanced ballistic protection is important for protecting lives in many fields including, for example, military applications and law enforcement. Although modern body armor and ground vehicle armor have saved countless lives, there still remains a need for enhanced armor providing either improved user protection, lighter weight, or a combination thereof. For example, some forms of modern body armor may have significant weight that can encumber a soldier or law enforcement officer in the field. Furthermore, susceptibility of body and vehicle armor to armor-piercing artillery is an ongoing shortcoming as well.

As an example of the importance of enhanced ballistics protection, the United States military began replacing standard Small Arms Protective Insert (SAPI) plates in protective armor with Enhanced Small Arms. Protective Insert (ESAPI) plates in 2005. State-of-the-art ESAPI plates now provide some protection from armor-piercing bullets but at a significantly higher monetary cost than standard SAPI plates. A call for a next generation plate capable of stopping even higher velocity ballistic threats has been issued by the United States military. The military's call to action has specifically noted the need for flexible systems capable of greater protective coverage without a significant increase in weight.

In view of the foregoing, new lightweight materials having enhanced ballistic protection for both personal and vehicular use would be of substantial benefit in both military and civilian applications. Not only would such materials offer improved ballistic protection, but they would also provide improved wearer comfort and improved vehicular performance over heavier materials currently in use.

### SUMMARY

In various embodiments, laminate materials having a first layer of a dilatant compound, a second layer of a ceramic material and a third layer of a strike face material are described herein. The second layer is between the first layer and the third layer.

In other various embodiments, laminate materials of the present disclosure have a first layer of a dilatant compound and a polymer fiber component, a second layer of a ceramic material and a third layer of a strike face material. The polymer fiber component is arranged in sub-layers within the first layer. The strike face material includes at least one metal underlayer, a polymer material, and a nanomaterial dispersed in the polymer material. The at least one metal underlayer is patterned with a plurality of holes. The polymer material fills at least a portion of the plurality of holes. The second layer is interposed between the first layer and the third layer.

In other various embodiments, dilatant compounds are described herein. The dilatant compounds include a silicone fluid and a nanomaterial dispersed in the silicone fluid. The nanomaterial is functionalized with at least one silane coupling agent. In some embodiments, the nanomaterial is HALLOYSITE nanotubes.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 shows a schematic of an illustrative response of a dilatant compound to shear conditions;

FIG. 2 shows an illustrative electron micrograph of HALLOYSITE nanotubes;

FIG. 3 shows an illustrative embodiment of a metal underlayer used in strike faces of the present disclosure;

FIG. 4 shows an illustrative electron micrograph of HALLOYSITE nanotubes filled with resorcinol diphenyl phosphate (RDP);

FIG. 5 shows an illustrative schematic of a laminate material produced according to one embodiment of the present disclosure; and

FIGS. 6A-6D show illustrative images of a laminate material of the present disclosure following ballistics testing. FIG. 6A shows the impact zone in the thermoplastic polyurethane/HALLOYSITE layer on the exterior of the strike face. FIG. 6B shows the impact zone in the thermoplastic polyurethane layer on the interior of the strike face. FIG. 6C shows the impact zone at the metal underlayer of the strike face. FIG. 6D shows the impact of the projectile in the high-molecular weight polyethylene layers after yawing.

### DETAILED DESCRIPTION

In the following description, certain details are set forth such as specific quantities, sizes, etc. so as to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing particular embodiments of the disclosure and are not intended to be limiting thereto. Drawings are not necessarily to scale.

While most of the terms used herein will be recognizable to those of ordinary skill in the art, it should be understood, however, that when not explicitly defined, terms should be interpreted as adopting a meaning presently accepted by those of ordinary skill in the art. In cases where the construction of a term would render it meaningless or essentially meaningless, the definition should be taken from Webster's Dictionary, 3rd Edition, 2009. Definitions and/or interpretations should not be incorporated from other patent applications, patents, or publications, related or not, unless specifically stated in this specification or if the incorporation is necessary for maintaining validity.

As used herein, the term “dilatant compound” will refer to, for example, a fluid whose viscosity is temporarily or permanently increased upon application of a shear force. In some embodiments herein, the term “dilatant compound” may be used synonymously with the term “shear thickening fluid.”

In various embodiments, laminate materials having a first layer of a dilatant compound, a second layer of a ceramic material and a third layer of a strike face material are described herein. The second layer is between the first layer and the third layer.

The laminate materials of the present disclosure advantageously rectify many of the perceived shortcomings present in many current materials used for ballistics protection, namely improved impact resistance and reduced weight. Furthermore, the laminate materials of the present disclosure are constructed largely from commercially available components and offer the potential to be produced at a significantly reduced cost compared to presently used ESAPI plates.

In some embodiments, the laminate materials of the present disclosure include one or more polymer layers binding the first layer, second layer and third layer to one another. In some embodiments, the first layer, second layer and third layer may include sub-layers bound together by one or more polymer layers. In some embodiments the polymer layers further include a nanomaterial filler such as, for example, a nanoclay (e.g., HALLOYSITE nanotubes, described in further detail hereinbelow) or carbon nanotubes (e.g., single-wall carbon nanotube, multi-wall carbon nanotubes, and combinations thereof. In other embodiments, the polymer layers do not include nanomaterial additives. In some embodiments, the polymers of the aforementioned polymer layers are thermoplastic polyurethanes. In some embodiments, the polymers of the polymer layers are silane functionalized with at least one silane coupling agent.

In various embodiments of the present disclosure, silane coupling agents typically are silanol species having a general formula HO—Si(R¹)(R²)(R³). Typically, the hydroxyl group reacts with an organic or inorganic substrate of interest, and any combination of R¹, R², and R³ may contain functionality suitable for cross-linking with another material. For example, in various embodiments, R¹, R² and R³ can be selected independently from hydrogen, hydroxyl, thiol, alkyl and cycloalkyl groups, alkenyl and cycloalkenyl groups, alkynyl and cycloalkynyl groups, aryl and heteroaryl groups, heterocyclic groups, amines, amides, esters, ethers, epoxides, and combinations thereof.

As used herein, the term “polyurethanes” will be used to refer to any of polyurethane polymers, polyurea polymers, and hybrid polyurethane/polyurea polymers. One of ordinary skill in the art will recognize that any of the various embodiments herein utilizing polyurethane polymers may be practiced equivalently using polyurea polymers, hybrid polyurethane/polyurea polymers, or other thermoplastic polymers known in the art having suitable properties for the chosen application. Thermoplastic polyurethanes are particularly advantageous for practicing the various embodiments of the present disclosure due to their ease of use in forming laminate materials. In terms of performance, thermoplastic polyurethane films represent a desirable compromise between cost and performance, as they are easily cut and handled for processing by lay-up and autoclave processing technology. Further, thermoplastic polyurethane coatings offer high curing rates, a wide range of operating temperature, ballistic resistance, chemical resistance and imperviousness to chemicals. These properties are among those that make thermoplastic polyurethanes well suited for use in the laminate materials of the present disclosure due to their suitability for use in a wide range of field conditions. Further, due to their amenability to lay-up processing, the thermoplastic polyurethanes may be evenly distributed between layers. In contrast, epoxies, resins or wet chemistry binders may not be evenly distributed, thereby leading to potential impact failure.

In some embodiments, thermoplastic polyurethanes may be used to coat the laminate materials of the present disclosure. In coating applications, the thermoplastic polyurethanes may again include a nanomaterial filler. Nanomaterial fillers advantageously confer strength to the coatings. Use of the thermoplastic polyurethanes as a coating or as a laminating material between layers may also provide protection from shock and vibration, particularly for the ceramic material. Alternative coating materials include, without limitation, epoxy polymers, silicone rubber, and other thermoplastic polymers.

In any of the various embodiments of the present disclosure, the thermoplastic polyurethanes may possess the ability to covalently bind to suitably functionalized organic and inorganic materials. Thermoplastic polyurethanes capable of such covalent bonding are now commercially available from Huntsman Polyurethanes. In some embodiments, the thermoplastic polyurethanes may be functionalized with a silane coupling agent in order to achieve the capability for covalent bonding. Covalent bonding advantageously increases the compatibility between layers composed of different materials and thereby strengthens the laminate materials in various embodiments of the present disclosure.

In various embodiments of the laminate materials of the present disclosure, the dilatant compound, the ceramic material and the strike face material are all silane functionalized with at least one silane coupling agent. As described hereinabove, silane functionalization provides the opportunity for cross-linking to strengthen the laminate materials. Further, as described hereinbelow, silane functionalization may strengthen individual components of the laminate materials by correcting defects in their structure.

In various embodiments, the ceramic material of the laminate material's second layer may be, for example, boron carbide, silicon carbide, cubic boron nitride and various combinations thereof. Cubic boron nitride, in particular, offers the potential to form thinner laminate layers while maintaining mechanical strength. A commercially viable route to cubic boron nitride is now available. In various embodiments, cubic boron nitride may be synthesized by the reaction of boron with carbon nitride at pressures greater than about 9 GPa. It is believe that cubic boron nitride may have mechanical properties that surpass those of diamond.

In various embodiments, the ceramic material is treated with a silane coupling agent. In various embodiments, the ceramic material is silane functionalized with at least one silane coupling agent. Without being bound by theory or mechanism, Applicant believes that silane functionalization not only increases compatibility by bonding to the other layers of the laminate material or thermoplastic polyurethane layers, but such functionalization also increases strength of the ceramic material by healing Griffith's flaws therein and reducing susceptibility to cracking. Conventional armor using silicon carbide or boron nitride is typically assayed in the field by X-ray to verify that the ceramic material is still functioning as intended and maintaining structural integrity. Silane functionalization may advantageously improve the field durability of the ceramic material in the present laminate materials or other armor applications. Other embodiments described herein may also improve the durability of the ceramic material by protecting it from fracturing. For example, laminating the ceramic material to the dilatant compound of the first layer may also improve the field durability of the ceramic material.

In some embodiments of the laminate materials, the first layer further includes polymer fibers. Illustrative polymer fibers suitable for forming the laminate materials of the present disclosure include, for example, ultra-high molecular weight polyethylene. Commercial sources of ultra-high weight polyethylene fibers include, for example, SPECTRA available from Honeywell and DYNEEMA available from Royal DSM (The Netherlands). However, one of ordinary skill in the art will recognize that other high performance polymers such as, for example, KEVLAR may form the polymer fibers in the laminate materials of the present disclosure.

Ultra-high molecular weight polyethylene fibers have been conventionally used in aerospace and high-performance consumer applications due to their high strength and low weight. Table 1 presents a summary of physical properties of SPECTRA 2000, an ultra-high molecular weight polyethylene fiber available from Honeywell, in comparison to KEVLAR, another polymer conventionally used in armor applications. Ultra-high molecular weight polyethylene fibers are particularly advantageous in these and in many other applications due to their resistance to chemicals, water, UV light and flex fatigue. Furthermore, their low dielectric constant makes them virtually transparent to radar. The SPECTRA 2000 fibers are produced by a gel-spinning process, followed by drawing steps which extend the polymer chains. Without being bound by theory or mechanism, it is believed that the linear, highly dense structure of ultra-high molecular weight polyethylene confers its superior mechanical properties. In contrast, low molecular weight polyethylene is a highly branched polymer, which may lead to relatively poor mechanical and thermal performance.

TABLE 1
Properties of Ultra-High Molecular Weight Polyethylene
(SPECTRA 2000) Compared to KEVLAR

| | SPECTRA 2000 | KEVLAR |
|---|---|---|
| Density (g/cm³) | 0.97 | 1.44 |
| Tensile Strength (GPa) | 3.25 | 2.9 |
| Tensile Modulus (GPa) | 116 | 135 |
| Elongation at Break (%) | 2.9 | 2.8 |
| Specific Modulus (GPa/g/cm³) | 120 | 94 |
| Maximum Use Temp. (° C.) | 100 | 250 |
| Water Absorption (%) | 0.01 | 3.7 |
| Flammability | Poor | Good |
| Abrasion Resistance | Good | Poor |
| UV Resistance | Excellent | Poor |
| Chemical Resistance | Excellent | Good |
| Relative Cost | Low | High |

As shown in Table 1, SPECTRA 2000 fibers are about 30% lighter than KEVLAR, which is currently used in ballistics applications and offers the opportunity for weight reduction in armor applications as a result. In addition to weight reduction, SPECTRA 2000 and other ultra-high molecular weight polyethylene fibers offer the potential for improved ballistic protection. For example, one of the more advantageous properties of ultra-high molecular weight polyethylene fibers is the ability to withstand high load strain weight velocities without failure. This feature is particularly relevant for its use in high velocity ballistics applications, such as those described in the present disclosure.

In some embodiments, the polymer fibers are arranged in a plurality of sub-layers within the first layer. In some embodiments, each of the plurality of sub-layers within the first layer is laminated to one another through a plurality of thermoplastic polyurethane sub-layers. In some embodiments, the polymer fibers are covalently bonded to the plurality of thermoplastic polyurethane sub-layers. For example, in some embodiments, the polymer fibers may be functionalized with a silane coupling agent and cross-linked with the thermoplastic polyurethane sub-layers. In some embodiments, the dilatant compound coats the polymer fibers. In some embodiments, the thermoplastic polyurethane sub-layers contain HALLOYSITE or another nanomaterial in order to increase puncture resistance.

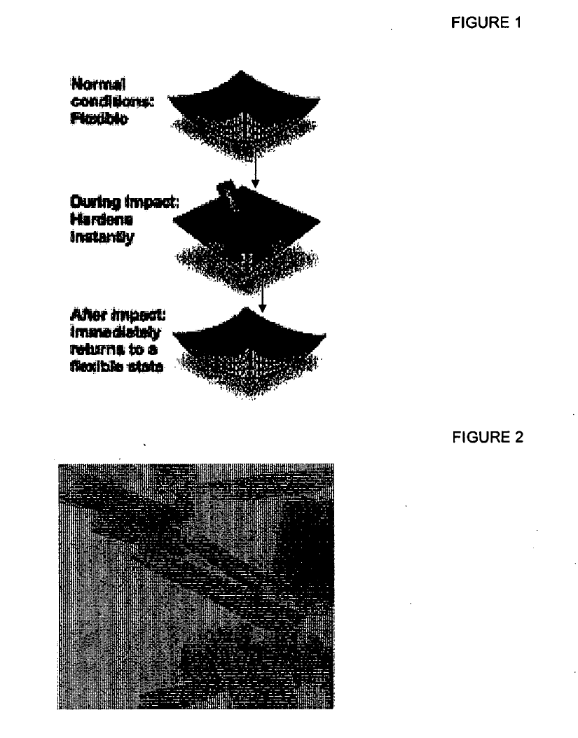

Dilatant compounds may be thought of as non-Newtonian fluids and are an example of “smart” materials that can sense and respond to changes in their environment. Under normal conditions, the molecules of a dilatant compound are weakly bonded and can move around with ease, but the pressure shock from an impact results in strengthening of the chemical bonds, thereby locking the molecules into place and hardening the material. Once the impact force dissipates, the bonds weaken and the material returns to its flexible state. Hardening of the dilatant compound prevents a projectile from penetrating the fluid in its hardened state. FIG. 1 shows a schematic of an illustrative response of a dilatant compound to shear conditions.

Dilatant compounds generally contain colloidal particles of less than about 100 μm in diameter dispersed within a continuous fluid. However, Applicant has developed a dilatant compound that does not contain such colloidal particles. Applicant's dilatant compound is a siloxane fluid cross-linked with silane coupling agents. This dilatant compound is described in PCT/US09/47500, filed Jun. 16, 2009, which is incorporated by reference herein in its entirety. In some embodiments of the present disclosure, the dilatant compound is a silicone fluid cross-linked with at least one silane coupling agent.

In some embodiments of the present disclosure, however, dilatant compounds may contain the above-described colloidal particles. For example, in some embodiments, dilatant compounds may contain nanomaterials. Illustrative nanomaterials include, for example, HALLOYSITE nanotubes and carbon nanotubes.

In some embodiments, dilatant compounds of the present disclosure may include a nanoclay material. Nanoclays have been studied extensively in polymer composites, but Applicant believes that their use as a component in dilatant compounds is presently unknown. In polymer composites, nanoclays are known to improve gas permeability, increase stiffness, provide better scratch resistance and improve thermo-mechanical response. Montmorillonite is an illustrative nanoclay material that has been used in making nanoclay polymer composites, particularly for those having improved flame retardancy. However, montmorillonite has significant limitations for making polymer composites such as, for example, a high cation exchange capacity and difficulty in exfoliation, that limit its compatibility with some polymer systems. Embodiments described herein present an alternative nanoclay material whose properties are more compatible with silicone fluids being used as dilatant compounds in some embodiments of the present disclosure.

In various embodiments of the present disclosure, the dilatant compound of the first layer further includes a nanomaterial. For example, in some embodiments, the nanomaterial may be HALLOYSITE nanotubes, a phyllosilicate material available from NaturalNano. FIG. 2 shows an illustrative electron micrograph of HALLOYSITE nanotubes. In other various embodiments, the nanomaterial may be, without limitation, Laponite synthetic silicates or carbon nanotube materials. In some embodiments, the HALLOYSITE nanotubes are further modified with at least one silane coupling agent. In some embodiments, the HALLOYSITE nanotubes are covalently bonded to the dilatant compound through the silane coupling agent.

In some embodiments of the present disclosure, the dilatant compound includes a silicone fluid cross-linked with at least one silane coupling agent. In some embodiments, the dilatant compound of the first layer further includes a nanomaterial, which may be dispersed therein in an embodiment. In some embodiments, the silane coupling agent covalently bonds the nanomaterial to the dilatant compound. In some embodiments, the nanomaterial is HALLOYSITE nanotubes. In some embodiments, the HALLOYSITE nanotubes are bonded to the at least one silane coupling agent.

Halloysite is a mineral naturally occurring in cylindrical form, as shown in FIG. 2. HALLOYSITE nanotubes are a phyllosilicate material from the kaolin clay group and have an empirical formula of Al₂O₃Si₂O₄.4(H₂O). HALLOYSITE nanotubes are hollow cylinders having a lumen size of about 20 nm and outer diameters of less than about 100 nm. Their lengths typically range from about 0.5 μm to about 5 μm. HALLOYSITE nanotubes have many of the same properties as carbon nanotubes such as, for example, strengthening and toughening of polymers, but without the cost prohibition of the latter. For example, HALLOYSITE nanotubes may be used to increase the impact strength of an epoxy nanocomposite by up to four times without impacting the modulus, strength, or thermal stability.

Furthermore, in various embodiments, the HALLOYSITE nanotubes may be functionalized with silane coupling agents in order to enhance their compatibilization with and dispersion into silicone fluids. In some embodiments, the HALLOYSITE nanotubes may further be cross-linked with the silicone fluid after being functionalized with the silane coupling agents. Furthermore, HALLOYSITE nanotubes are able to hydrogen bond to polymer substrates, strengthening the laminate materials of the present disclosure and conferring additional puncture resistance thereto.

HALLOYSITE nanotubes are advantageous over other nanoclay materials for dispersal in silicone-based dilatant compounds and other polymer materials. For example, relative to montmorillonite, HALLOYSITE nanotubes have a much lower cation exchange capacity and reduced swelling upon wetting. These properties ease the dispersion ability of the HALLOYSITE nanotubes. Furthermore, the tubular shape and inner lumen diameter of HALLOYSITE nanotubes are amenable for being filled with various additives. For example, in some embodiments of the present disclosure the dilatant compound may fill the lumen of the HALLOYSITE nanotubes. In other embodiments, additives such as, for example, UV stabilizers or corrosion inhibitors may fill the lumen of the HALLOYSITE nanotubes. Without being bound by theory of mechanism, Applicants believe that filling of the lumen may also lead to improved puncture resistance of the laminate materials of the present disclosure.

In various embodiments of the present disclosure, the dilatant compound may be intercalated into a yarn or a fabric. Since dilatant compounds maintain their properties down to micro-size scale and lower, application to very small surface areas such as yarns and fabrics becomes possible. Although dilatant compounds have desirable compression and shear response, they typically have poor tensile strength. Therefore, in various embodiments of the present disclosure, the dilatant compound is combined with a fiber component (e.g., polymer fibers) to yield a high tensile strength composite material having impact and puncture resistance. For example, in various embodiments of the present disclosure, dilatant compounds may be combined with KEVLAR or ultra-high molecular weight polyethylene fibers.

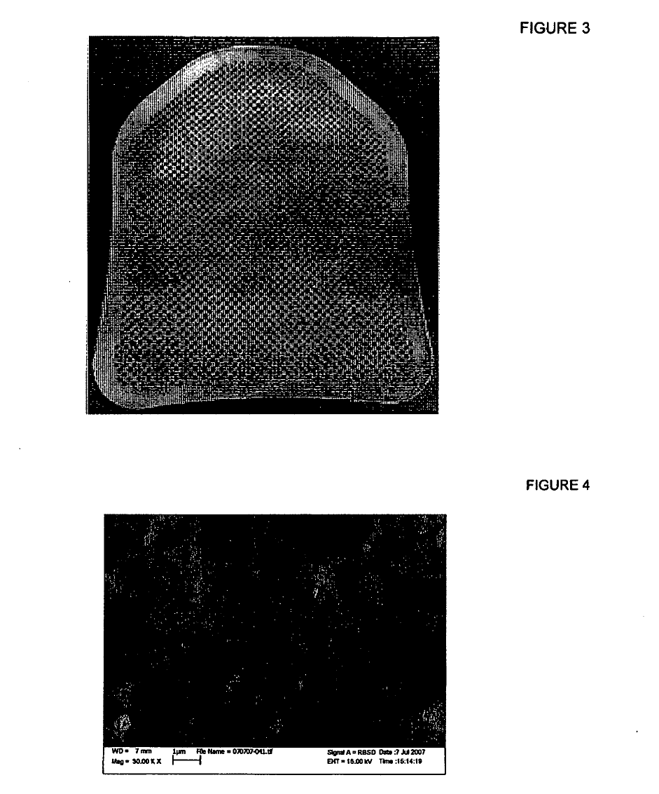

In various embodiments, a strike face material forms the third layer of the laminate materials of the present disclosure. In various embodiments, strike faces of the present disclosure are a composite material formed from at least one metal underlayer and a polymer material. In some embodiments, the at least one metal underlayer is patterned with a plurality of holes in, for example, a “honeycomb” arrangement. FIG. 3 shows an illustrative embodiment of a metal underlayer used in strike faces of the present disclosure. In various embodiments, the at least one metal underlayer is silane functionalized with at least one silane coupling agent.

In various embodiments of the laminate materials, a polymer material coats the at least one metal underlayer. In some embodiments, the polymer material fills at least a portion of the plurality of holes in the metal underlayer. In some embodiments, the polymer material further includes a nanomaterial filler dispersed in the polymer material. Hence, in various embodiments, at least a portion of the holes in the metal underlayer are filled with both polymer material and nanomaterial filler. In some embodiments, the polymer material is a polyurea or polyurethane (e.g., a thermoplastic polyurethane). In some embodiments, the polymer material is spray coated on to the metal underlayer.

In some embodiments, nanomaterial fillers for the polymer materials of the strike face include, for example, HALLOYSITE nanotubes, carbon nanotubes and combinations thereof. Carbon nanotubes in the polymer material of the strike face can include without limitation, single-wall carbon nanotubes and carbon nanotubes having more than one wall (e.g., multi-wall carbon nanotubes).

In various embodiments, the at least one metal underlayer, the polymer material, the nanomaterial or a combination thereof may be treated with one or more silane coupling agents and functionalized therewith. Such treatment advantageously increases the interaction between the metal underlayer, the polymer material and/or the nanomaterial filler. In some embodiments, the at least one metal underlayer, the polymer material, and the nanomaterial are silane functionalized with at least one silane coupling agent.

In some embodiments, the at least one metal underlayer is formed from a metal alloy. For example, in some embodiments, the metal underlayer is TiAl₆V₄. In some embodiments, the metal underlayer is Ti₄V₆. In some embodiments, the metal underlayer is Ti₄Al₆.

Applicant has found that strike faces of the present disclosure advantageously change the shape trajectory and rheology of a ballistic threat. Without being bound by theory or mechanism, Applicant has found that the holes in the metal underlayer act as a cutting edge that turns and yaws the projectile. Further, the polymer material and its dispersed nanoparticles provide a tough surface that increase dwell time of the projectile to allow the strike face to fracture the projectile more efficiently. Strike faces of the present disclosure are further reinforced by the ceramic material of the second layer. Still without being bound by theory or mechanism, Applicant believes that the tough ceramic material forces the nanoparticles of the strike face to displace energy outward toward the ballistic threat. As a result, the projectile's own kinetic energy is used against itself when impacting the laminate materials of the present disclosure. Laminate materials of the present disclosure typically divide traditional lead core projectiles and armor-piercing projectiles into several flattened pieces before being stopped at or before the ceramic material of the second layer. The dilatant compound of the third layer provides additional protective material. The strike faces of the present disclosure are particularly advantageous for stopping armor-piercing projectiles, since they result in shedding of the penetrating tip of the projectile. Once the penetrating tip has been removed, only an ordinary projectile (i.e., a bullet) remains, which is much easier to stop as its kinetic energy begins to spread out over a wider area upon passing through the laminate materials.

The strike faces of the present disclosure are distinguished from strike faces used in conventional protective armor not only in their composition but in the way in which they repel a ballistic threat. Conventional strike faces have typically sought to provide ballistic protection by using a thick, dense strike layer (e.g., a solid metal or ceramic material) to repel a ballistic threat, followed by layers of high-performance shielding underneath to stop the fragments of the initial impact. For example, current ESAPI armor plates employ a ceramic strike face made from boron carbide or silicon carbide backed by layers of KEVLAR or other high-performance polymer. These conventional strike faces make no attempt to change the trajectory of the projectile, however. In contrast, strike faces of the present disclosure advantageously change the trajectory of the projectile as it impacts the strike face, resulting in cutting of the projectile and yawing as the impact fragments are stopped within subsequent layers of the laminate material. Furthermore, the fact that the strike faces are not required to be thick and dense in the present embodiments results in the realization of advantageous reductions in weight.

In other various embodiments of the strike faces of the present disclosure, a metal foam may be placed behind the metal underlayer. In some embodiments, the metal foam may be coated with a polymer and/or a nanomaterial prior to being placed behind the metal underlayer. In such embodiments, exceptional shock mitigation is observed, along with increased projectile dwell time, yaw and fracture.

In addition to enhanced ballistic projection provided by HALLOYSITE nanotubes, other beneficial property enhancements may also be realized by having these nanomaterials included as a component of the strike face, for example, in a polymer material coating the metal underlayer. As noted above, HALLOYSITE nanotubes can be both filled in their lumen and coated with various additives. FIG. 4 shows an illustrative electron micrograph of HALLOYSITE nanotubes filled with resorcinol diphenyl phosphate (RDP), a flame retardant. As shown in FIG. 4, the HALLOYSITE nanotubes are both filled and surface coated with the RDP. Inclusion of RDP with the HALLOYSITE nanotubes confers beneficial flame retardancy to polymer composites produced therefrom. For example, poly(methylmethacrylate) (PMMA) treated with decabromodiphenyl ether and antimony oxide fails the UL-94 V0 flame retardancy test at 1.5 mm thickness. However, when a 5% loading of HALLOYSITE nanotubes treated with RDP is dispersed in the PMMA, the resultant composite material passes the UL-94 V0 test. Normally, inclusion of RDP in a polymer would significantly reduce the observed modulus. However, when RDP is included with HALLOYSITE nanotubes, the modulus may be maintained while still conferring flame retardancy. Hence, in some embodiments, polymer coatings of the strike face may be flame retardant, as well as providing ballistic protection, while maintaining flexibility and abrasion resistance. Such flame retardancy may also be beneficial for field use of the laminate materials described herein.

In various embodiments, laminate materials of the present disclosure have a first layer of a dilatant compound and a polymer fiber component, a second layer of a ceramic material and a third layer of a strike face material. The polymer fiber component is arranged in sub-layers within the first layer. The strike face material includes at least one metal underlayer, a polymer material, and a nanomaterial dispersed in the polymer material. The at least one metal underlayer is patterned with a plurality of holes. The polymer material fills at least a portion of the plurality of holes. The second layer is interposed between the first layer and the third layer. In some embodiments, at least the metal underlayer, the polymer material, the nanomaterial and the ceramic material are silane functionalized.

In some embodiments, the first layer further includes HALLOYSITE nanotubes dispersed in the dilatant compound. In some embodiments, the dilatant compound is a silicone fluid cross-linked with at least one silane coupling agent. In such embodiments, the HALLOYSITE nanotubes are silane functionalized with the at least one silane coupling agent.

In other various embodiments, dilatant compounds are described herein. The dilatant compounds include a silicone fluid and a nanomaterial dispersed in the silicone fluid. The nanomaterial is functionalized with at least one silane coupling agent. In some embodiments, the nanomaterial is HALLOYSITE nanotubes. In some embodiments, the nanomaterial is cross-linked to the silicone fluid through the at least one silane coupling agent.

### Experimental Examples

The following examples are provided to more fully illustrate some of the embodiments disclosed hereinabove. It should be appreciated by those of ordinary skill in the art that the techniques disclosed in the examples that follow represents techniques that constitute illustrative modes for practice of the disclosure. Those of ordinary skill in the art should, in light of the present disclosure, appreciate that many changes can be made in the specific embodiments that are disclosed and still obtain a like or similar result without departing from the spirit and scope of the disclosure.

### Example 1

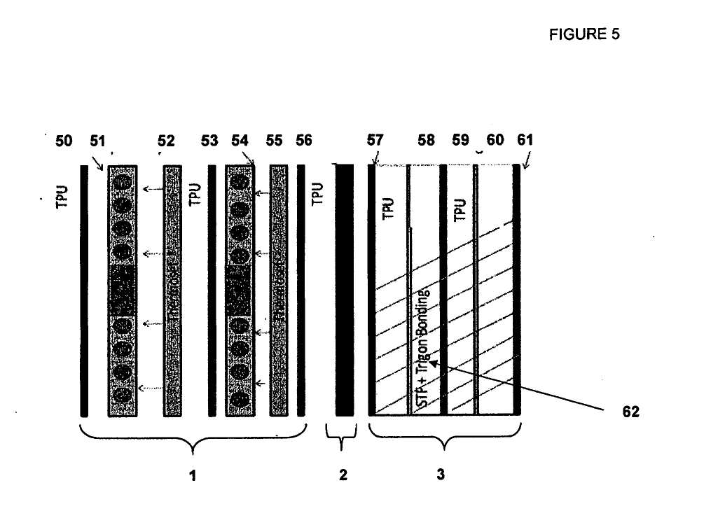

Ballistic Testing of an Illustrative Laminate Material. FIG. 5 shows an illustrative schematic of a laminate material produced according to one embodiment of the present disclosure. Strike face 1 is composed of two layers of metal underlayer 51 and 54, each individually in contact with thermoset layers 52 and 55. Strike face 1 is further coated on its exterior with a thermoplastic polyurethane layer 50. Thermoplastic polyurethane layer 53 laminates the metal underlayer/thermoset layer combination together within strike face 1. Strike face 1 is laminated to ceramic layer 2 through thermoplastic polyurethane layer 56. In the example shown, the ceramic layer 2 is cubic boron nitride. Ceramic layer 2 is further laminated to shear thickening layer 3 through thermoplastic polyurethane layer 57. Shear thickening layer 3 includes high-molecular weight polyethylene layers 58 and 60 laminated to one another with thermoplastic polyurethane layer 59. The exterior of shear thickening layer is coated with thermoplastic polyurethane layer 61. Dilatant compound 62 is dispersed on high-molecular weight polyethylene layers 58 and 60 throughout shear thickening layer 3. As noted above, any or all components may be treated with silane coupling agents in order to increase compatibilization and bonding to one another. Each of the thermoplastic polyurethane layers contain HALLOYSITE nanotubes.

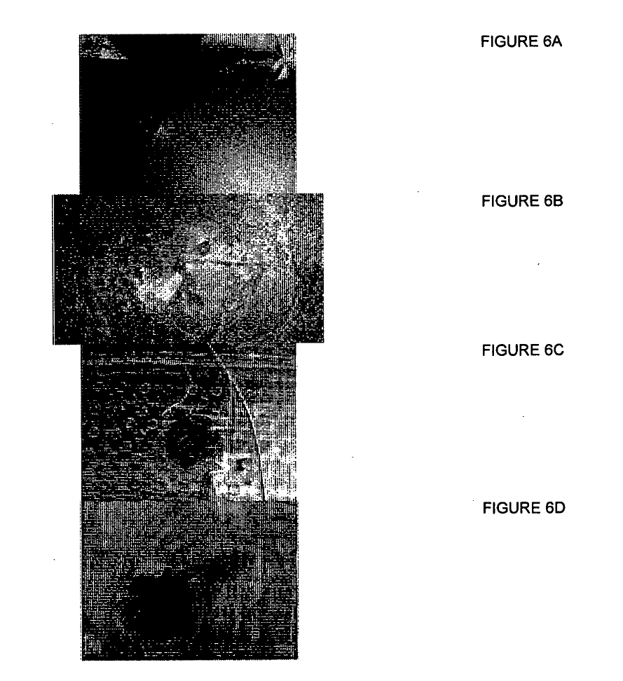

FIGS. 6A-6D show illustrative images of a laminate material of the present disclosure following ballistics testing. FIG. 6A shows the impact zone in the thermoplastic polyurethane/HALLOYSITE layer 50 on the exterior of the strike face. FIG. 6B shows the impact zone in the thermoplastic polyurethane layer 53 on the interior of the strike face. FIG. 6C shows the impact zone at the metal underlayer 54 of the strike face. FIG. 6D shows the impact of the projectile in the high-molecular weight polyethylene layers 58 and 60 after yawing. The impact shots are from a 7.62 AP M2 projectile, a 30 caliber armor-piercing round traveling at 2800 feet per second. The images show the yaw and spread of the projectile as it passes through the laminate material. Rather than piercing the laminate material in a pin hole and reaching the wearer, the armor piercing material of the projecting is removed and the impact force is dissipated over a wider area in the laminate material. Impact fragments do not penetrate completely through the laminate material, thereby providing protection to the wearer.

From the foregoing description, one of ordinary skill in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure, which is defined in the following claims.

What is claimed is the following:

1. A laminate material comprising:
a first layer comprising a dilatant compound;
a second layer comprising a ceramic material; and
a third layer comprising a strike face material;
wherein the second layer is interposed between the first layer and the third layer.

2. The laminate material of claim 1, wherein the dilatant compound, the ceramic material, and the strike face material are all silane functionalized with at least one silane coupling agent.

3. The laminate material of claim 1, wherein the first layer further comprises polymer fibers.

4. The laminate material of claim 3, wherein the polymer fibers are arranged in a plurality of sub-layers within the first layer.

5. The laminate material of claim 4, wherein each of the plurality of sub-layers within the first layer are laminated to one another through a plurality of thermoplastic polyurethane sub-layers.

6. The laminate material of claim 3, wherein the polymer fibers comprise ultra-high molecular weight polyethylene.

7. The laminate material of claim 3, wherein the dilatant compound coats the polymer fibers.

8. The laminate material of claim 1, wherein the dilatant compound comprises a silicone fluid cross-linked with at least one silane coupling agent.

9. The laminate material of claim 8, wherein the first layer further comprises a nanomaterial.

10. The laminate material of claim 9, wherein the nanomaterial comprises HALLOYSITE nanotubes.

11. The laminate material of claim 10, wherein the HALLOYSITE nanotubes are bonded to the at least one silane coupling agent.

12. The laminate material of claim 1, wherein the first layer further comprises a nanomaterial.

13. The laminate material of claim 12, wherein the nanomaterial comprises HALLOYSITE nanotubes.

14. The laminate material of claim 13, wherein the HALLOYSITE nanotubes are further modified with at least one silane coupling agent.

15. The laminate material of claim 1, wherein the ceramic material is selected from the group consisting of boron carbide, silicon carbide, cubic boron nitride and combinations thereof.

16. The laminate material of claim 15, wherein the ceramic material is silane functionalized with at least one silane coupling agent.

17. The laminate material of claim 1, wherein the strike face material comprises a composite comprising at least one metal underlayer and a polymer material.

18. The laminate material of claim 17, further comprising:
a nanomaterial dispersed in the polymer material.

19. The laminate material of claim 18, wherein the at least one metal underlayer, the polymer material, and the nanomaterial are silane functionalized with at least one silane coupling agent.

20. The laminate material of claim 18, wherein the nanomaterial is selected from the group consisting of carbon nanotubes, HALLOYSITE nanotubes, and combinations thereof.

21. The laminate material of claim 17, wherein the at least one metal underlayer comprises a TiAl₆V₄ alloy.

22. The laminate material of claim 17, wherein the at least one metal underlayer is patterned with a plurality of holes.

23. The laminate material of claim 22, further comprising:
a nanomaterial dispersed in the polymer material; and
wherein the polymer material fills at least a portion of the plurality of holes.

24. A laminate material comprising:
a first layer comprising a dilatant compound and a polymer fiber component;
wherein polymer fiber component is arranged in sub-layers within the first layer;
a second layer comprising a ceramic material; and
a third layer comprising a strike face material;
wherein the strike face material comprises:
at least one metal underlayer;
wherein the at least one metal underlayer is patterned with a plurality of holes;
a polymer material; and
a nanomaterial dispersed in the polymer material;
wherein the polymer material fills at least a portion of the plurality of holes;
wherein the second layer is interposed between the first layer and the third layer.

25. The laminate material of claim 24, wherein at least the metal underlayer, the polymer material, the nanomaterial, and the ceramic material are silane functionalized.

26. The laminate material of claim 25, wherein the first layer further comprises HALLOYSITE nanotubes dispersed in the dilatant compound;
wherein the dilatant compound comprises a silicone fluid cross-linked with at least one silane coupling agent; and
wherein the HALLOYSITE nanotubes are silane functionalized with the at least one silane coupling agent.

27. A dilatant compound comprising:
a silicone fluid; and
a nanomaterial dispersed in the silicone fluid;
wherein the nanomaterial is functionalized with at least one silane coupling agent.

28. The dilatant compound of claim 27, wherein the nanomaterial is cross-linked to the silicone fluid through the at least one silane coupling agent.

29. The dilatant compound of claim 27, wherein the nanomaterial comprises HALLOYSITE nanotubes.
